(19) United States
(12) Patent Application Publication
(10) Pub. No.: US 2004/0225509 A1
(43) Pub. Date: Nov. 11, 2004

(54) Use of financial transaction network(s) information to generate personalized recommendations

(76) Inventor: Olivier Andre, Liedekerke (BE)

Correspondence Address: HOVEY WILLIAMS LLP, Suite 400, 2405 Grand, Kansas City, MO, 64108, US

(21) Appl. No.: 10/431,411

(22) Filed: May 7, 2003

(51) Int. Cl. G06F 17/60

(52) U.S. Cl. 705/1

(57) ABSTRACT

A computer-implemented service recommends merchants affiliated to one or several financial transaction networks based on transaction information and other available information. In one embodiment, the service uses merchants where the member recently transacted to generate a list of additional merchants that are predicted to be of interest to the member, wherein an additional merchant is selected to be included in the list based in-part upon whether that merchant is related to one or more of the transacted merchants. The merchants relationships are preferably determined by an off-line process that analyzes members transactions histories and other available information to identify correlations between merchants.

### FIELD OF THE INVENTION

The present invention relates generally to data processing systems, and more particularly, to information filtering and recommendation systems. More specifically, the invention relates to methods for recommending merchants affiliated to one or many financial transaction networks to members and non-members of the financial transaction networks.

### BACKGROUND OF THE INVENTION

Financial Transaction Networks are organizations which offer to individuals and companies alternatives to cash for paying for goods and services at affiliated merchant, as well as other related or non-related services. They are composed of several parties of which the main ones are described hereby:

Financial Transaction Schemes are the institutions that provide the payment and/or cash withdrawal network through which the transactions take place and lay down related rules and regulations.

Issuers are (usually financial) institutions which are licensed by the Financial Transaction Scheme to issue payment tools (usually a plastic card or any means identifying members) to members with whom they hold contractual agreements.

Members of the scheme are individuals to whom a payment tool (usually a piece of plastic with information embossed, coded on magnetic stripe and potentially in a chip, called a “card”) is issued, which allow them to use/access the financial transaction network services.

Acquirers are (usually financial) institutions which are licensed by the Financial Transaction Scheme to affiliate merchants to accept payment tool-based transactions.

Merchants are any business which is involved in retailing and has met the qualification to accept the defined payment tool. Individuals linked to the Merchant can also be members.

Transaction processors deal with the settlement of the transactions. Their role is to manage the exchange of transactional information (clearing) and the actual fund transfers.

A closed loop network is a payment network where the issuers and the acquirers are one same institution within a geographic coverage (and if not the case then the two institutions are highly linked), and the financial transaction scheme and the international transaction processor also being one global institution. This structure allows for better control over the network and therefore more qualitative information at all levels.

The main Financial Transaction Networks payment tools are:

Charge cards are “pay later” payment tools that allow the member to defer the cost of the transaction until the end of the payment cycle (usually monthly) and the following grace period (usually a few days), when it has to be paid in full. Usually not linked to a bank account.

Deferred debit cards are “pay later” payment tools that allow the member to defer the cost of the transaction until the end of the payment cycle (usually monthly), when the amount is debited from a linked bank account.

Credit cards are “pay later” payment tools that allow the member to pay only a minimum percentage of the amount due at the end of the payment cycle, while the remaining amount revolves till the end of the next payment cycle with interests accrued.

Debit cards are “pay now” payment tools where the costs of purchases made are directly debited from a linked bank account.

Digital cash is an encrypted digital form of money that can be used for payments.

Electronic purses are a smart card or tool onto which money is pre-loaded, to be later used to make small value payments that are deducted from the amount stored on the tool—which can be re-loaded with additional amounts. etc.

All these payment tools can be plastic card based, mobile phone based, personal assistant based, etc.

Examples of major Financial Transaction Networks are “Visa”, “MasterCard”, “Discovery”, “American Express”, “Diners Club”, “JCB”, “Maestro”, and “Mondex”.

Examples of closed loop Financial Transaction Networks are “American Express” and “Diners Club”.

Relationships on the members' side of financial transaction networks can be analyzed at different levels, being mainly four:

At the member level: the member can have multiple payment tools from one issuer/network, for instance to separate private and corporate expenses;

At the payment tool level: a payment tool has, in the current environment, only one member attached to it (it is a personal tool) but this could change when dematerialized on a computer or a cell phone;

At the account level: an account is the level at which the issuer bills its members, it can have multiple payment tools attached to it, belonging to different individuals, for instance the main member and members of its family like spouse and children;

At the relationship level: a payment tool issuer can store information about existing “family” or “corporate” relationships between multiple accounts or payment tools.

Financial transaction networks have started as a community of persons that goes to the same places and/or have the same interests and provided their members with two base benefits: a non-cash payment tool and the membership of a community of users.

The modern financial transaction networks started as charge cards which have subsequently evolved into debit cards and credit cards, and lately into digital cash, electronic purses, and mobile phone payment tools.

Since the beginning, the financial transaction networks have evolved technically and grown to replace cash in many instance, but have lost the functionality/idea of membership of a community. This may result in below-optimal transaction and satisfaction levels, and for the members a sense of being treated as a number, not as a member of a community.

To differentiate their services to members and increase members and payment tools portfolio acquisition, retention and activity, the financial transaction networks and their issuers have relied on various techniques like affinity programs and loyalty schemes (cash-back or points/miles based).

However affinity programs can be complex and expensive to build, are limited to certain interests and are non-adaptive to changes in the member interest. And alternatives to the right partner with the right target group in its portfolio are usually difficult to find, which increases costs of partnership.

Loyalty schemes are expensive to successfully set up, run and differentiate. They can also be perceived by merchants as being awarded at their expense to the members of the network especially in case of a (perceived) high discount rate (which is the merchant's cost of transaction).

Globally merchants more and more perceive the financial transaction networks as a commodity for which they want to pay as little as possible. They perceive little added value for them from accepting these networks, although they feel obliged to accept the main ones. This creates a risk for the smaller networks to be driven out of the market if they don't provide some added value to the merchants and don't differentiate from the major networks.

On the other side improvements in information technology have allowed the development of Recommendation Systems that predict the preference of particular users based on attributes known about the user or a past history of preferences or consumption by the user. “One common application for recommendation services involves recommending products to online customers. For example, online merchants commonly provide services for recommending products (books, compact discs, videos, etc.) to customers based on profiles that have been developed for such customers. Recommendation services are also common for recommending Web sites, articles, and other types of informational content to users.” (excerpt from patent U.S. Pat. No. 6,266,649 B1)

### SUMMARY OF THE DISCLOSURE

The present invention addresses these problems and other problems by providing a computer-implemented service and associated methods for recommending merchants affiliated to one or several financial transaction networks to members and non-members of the networks.

The purpose of this invention is to offer to at least a group of members, preferably substantially all members of a payment network, the ability to receive personalized recommendation as if the person was well known by the person in charge of the merchants: Imagine you are a good friend of the person in charge of the affiliated merchants in a certain region. This person knows all the main places around that accept the payment tool, and their main characteristics like atmosphere, price, quality, value, etc. And this person knows your tastes and preferences, therefore he is able to recommend you places you don't know yet but that you are very likely to enjoy.

A table of similarity factors is calculated between each affiliated merchant (or the major ones); each similarity factor represents a degree of correlation between the fact that members that go to the first merchant go to the second one.

Regardless of the method used to generate the similarity factors, they are used to select a plurality of merchants that have a high degree of correlation to a merchant. Using the similarity factors and other information available to the institution that manages the network, a recommendation is made to the member for a merchant where the member has not yet transacted (or at least not recently).

In a particular embodiment, a member of the network receives recommendations with his monthly statement, based on the transactions information and previous information and the similarity table.

In another embodiment a member calls in or logs into a site and is given the latest recommendations for him, based on his latest available transactions information and the similarity table.

In a third embodiment a member calls in or logs into a site and based on a geographical/shop type request is given the latest recommendations for him, based on the latest available member's transactions information and the latest similarity table.

In another embodiment a member or a non-member calls in or logs into a Web server and based on one or multiple reference merchant(s) and a geographical/shop type request is given the latest recommendations for him, based on the latest similarity table.

In all cases the number of the recommendations that are provided to the member can be defined as above, with or without, a certain cut-off similarity rate (which can be defined by the member or centrally by default or linked to other parameters) or as a certain maximum number of recommendations (again which can be defined by the member or centrally by default or dependent on other parameters)

In another embodiment merchants receives information on transactions that happened in their or other shops subsequent to recommendations.

An important benefit of the service is that the recommendations are generated without the need for the members of the network to rate affiliated merchants. Another benefit is that an increased usage of the network by the member increases his likelihood to receive additional and meaningful recommendations. A third benefit is that increased acceptance of the payment tool by the merchants increases their likelihood to be recommended to members and therefore to generate additional transaction as a result of its acceptance of the network payment tool.

One aspect of the invention is that to generate the mapping of merchants to similar merchants, a process will identify correlations between known interests of members in particular merchants. For example, in the embodiment described in detail below, the mappings are generated by periodically analyzing members transactions histories to identify correlations between transactions at merchants. The similarity between two merchants is preferably measured by determining the number of members that have an interest in both merchants relative to the number of members that have an interest in either one (e.g. merchants A and B are highly similar because a relatively large portion of the members that transacted at one of the merchants also transacted at the other merchant). Interest can be derived from the existence of transaction(s) (Boolean value), the number of transactions at merchants, the value of transactions at merchants, the time of the transactions at merchants, a combination of all these information, or a combination of these information with other information gathered during the transaction process or existing in the financial transaction network database. This will generate a table of interest similarity.

Another aspect of the invention is that to generate a set of recommendations for a given member, the service can use the set of merchants where the member has used its payment tool, combine it to the table of interest similarity to generate a list of recommended merchants. For example, if there are four merchants where the member has recently used the payment tool, the service may retrieve the interest similarity lists for these four merchants from the table of interest similarity and combine these lists.

Another aspect of the generation of the set of recommendations is that the information from the similar merchants table may be appropriately weighted (prior to being combined) based on indications of the member's recent liking. For example, the set of recommendations for a last week transaction may be weighted more heavily than the set of recommendations for a transaction that took place three months ago. This will have the effect of increasing the likelihood that the merchants in that list will be included in the recommendations that are ultimately presented to the member.

Another aspect of the invention is that to generate a set of recommendations for a given member, the service can use a (or multiple) reference merchant(s) communicated by the member to the payment tool issuer, and combine it to the table of interest similarity to generate a list of recommended merchants.

Another aspect of the invention is that the list of recommended merchants can be further weighted using other information existing in the financial transaction network database (like “Italian restaurant” or “fashion boutique”, or the location), based on the request from the member.

The recommendations can be made at the members level, at the account level or at the payment tool level, depending on the decision of the institution or of the member.

The sets of recommendations can be communicated to the member via any communication tool, being outgoing communication from the financial transaction network (like statements or mails) or two-ways communication between the network and the customer (like phone or Internet).

An important benefit of the invention is that it uses the member transaction information as proxy for the customer interest in a merchant, therefore there is no need for the member to provide any input or any explicit ratings to be part of the service. The preference of the member is inferred from the transactions data, without any explicit statement of preference per see.

Another important benefit of the invention is that the more the member uses the payment tool, the better the recommendations that can be made to the member (as more information is known about the member's preferences).

A third important benefit of the invention is that the more the merchant accepts the payment tool, the more he is likely to be recommended to other members of the network (as the merchant's potential correlation with other merchants is likely to increase with the number of transactions)

Another benefit is for the financial transaction network: the better the recommendations made to the members, the more they will use the payment tool; the more a merchant accepts the payment tool, the more he will be recommended to members and will increase its transactions. As a result the financial transaction network automatically deepens its relationship with its members and its affiliated merchants, creating a virtuous circle in favor of the use of this payment tool.

Because the financial transaction network possess transaction information about transactions almost in real-time, or at minimum within days, the table of interest similarity can be regenerated periodically based on up-to-date transaction data, and therefore the recommendations lists tend to reflect the members' current transaction trends.

### BRIEF DESCRIPTION OF THE DRAWINGS

These and other features of the invention will now be described with reference to the drawings summarized below. These drawings and the associated descriptions are provided to illustrate a preferred embodiment of the invention, and not to limit the scope of the invention.

FIG. 1 illustrates the overall description of an implementation of a recommendation service that operates in accordance with the invention, and represents the flows of information between the components.

FIG. 2 illustrates a sequence of steps that are performed in the table generation process step A to generate a similarity table

FIG. 3a illustrates a sequence of steps that are performed in the process step B1 to generate personal recommendations

FIG. 3b illustrates a sequence of steps that are performed in the process step B2 to generate personal recommendations

FIG. 4 illustrates a sequence of steps that are performed in the process step C1 for a merchant to enrich the Merchant Information Table

FIG. 5 illustrates a sequence of steps that are performed in the process steps C2 for a member to enrich the Merchant Information Table

FIG. 6 illustrates a sequence of steps that are performed in the process step D for a member to access the Merchant Information Table information

FIG. 7 illustrates a sequence of steps that are performed in the process step E for the analysis of the matching of the Recommendation Tracking Table with subsequent transactions

FIG. 8 illustrates a Similarity Table

FIG. 9 illustrates a Merchant Information Table

FIG. 10 illustrates a Recommendations Tracking Table

FIG. 11a illustrates in a preferred embodiment the Payment Tools Table at the end of period 1

FIG. 11b illustrates in a preferred embodiment the Merchants Table at the end of period 1

FIG. 11c illustrates in a preferred embodiment the Merchants Information Tables at the end of period 1

FIG. 11d illustrates in a preferred embodiment the Merchants Information Tables at the end of period 2

FIG. 11e illustrates in a preferred embodiment the Similarity Table for period 2

FIG. 11f illustrates in a preferred embodiment the Transactions Table for period 1

FIG. 11g illustrates in a preferred embodiment the table of the Recommendation Lists at the beginning of period 2

FIG. 11h illustrates in a preferred embodiment the Transactions Table for period 2

FIG. 11i illustrates in a preferred embodiment the Successful Recommendations Table for period 2

FIG. 11j illustrates in a preferred embodiment the Recommendation List for the payment tool “Pymt_{—}12” for period 2

### DETAILED DESCRIPTION OF PREFERRED EMBODIMENTS

The various feature and methods of the invention will now be described in the context of a closed loop network in one territory, in specific implementations thereof, that are used to recommend affiliated merchants to members of the network and other individuals. As will be recognized to those skilled in the art, the disclosed methods can also be used in any financial transaction network for any number of territories or geographic coverage to recommend affiliated merchants to members of the network and other individuals. It can also be used for multi-network recommendations, if this is the available information.

Throughout the description, reference will be made to specific implementation details of the recommendation service and the financial transaction network. These details are provided in order to illustrate preferred embodiments of the invention, and not to limit the scope of the invention. The scope of the invention is set forth in the appended claims.

The related payment network process steps are only described as necessary to understand their relation with the invention.

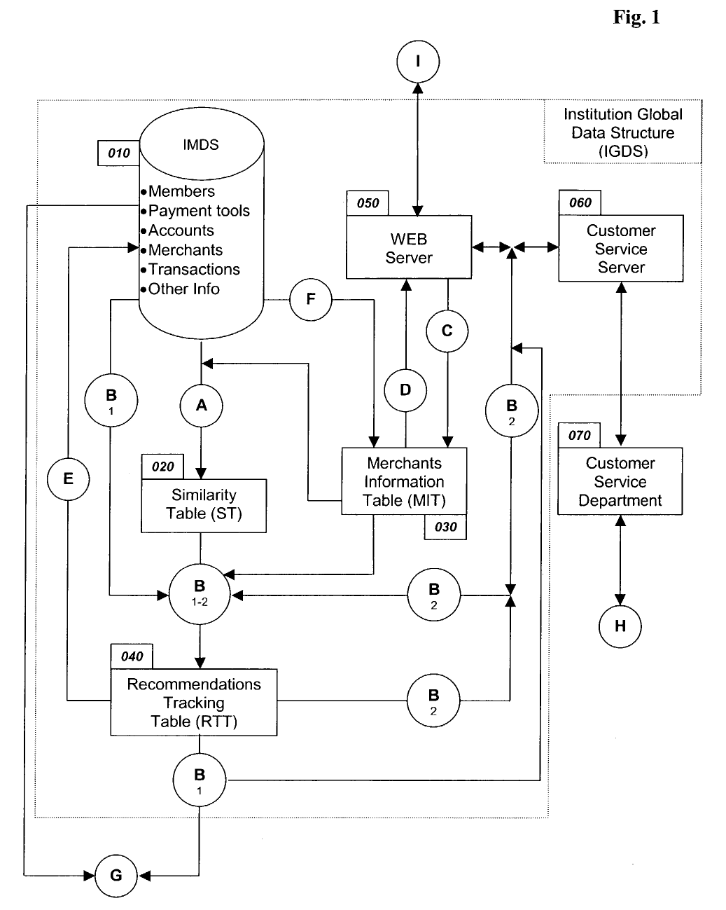

FIG. 1 illustrates the overall components and process steps of an implementation of the invention. The arrows show the main flows of information for understanding this invention while each process step or optional process step is represented by a letter (A to I). The claimed systems or methods use one or more process steps or portions thereof, said process steps or portions thereof using one or more databases, tables, etc as disclosed hereafter.

List of the Main Systems, Databases, Tables, and Other Items (as Appearing in FIG. 1):

010 A computer system including a computer-readable storage medium comprising a specific data structure which stores and manages network and institution related information about members, payment tools, accounts, merchants, transactions and other information: hereafter the Institution Main Data Structure (IMDS). The IMDS can have various memory and/or connection means to one or more data bases, such as by wires, internet, etc.

020 A computer-readable storage medium comprising a specific similarity data structure which maps items from the merchants database to sets of similar items from the same merchants database and additionally contains items similarity index values, each index indicating a degree of similarity between two merchants: hereafter the Similarity Table (ST), built and/or updated in process A.

For each merchant listed in the Similarity Table, the following information is for example included: a unique merchant identification code and for stored similar merchants a unique merchant identification code and a similarity index;

030 A computer-readable storage medium comprising a specific data structure which contains items from the merchants database and supplementary information: hereafter the Merchant Information Table (MIT) built and/or updated in process F, updated in process C1, C2, and C3 and consulted in process D.

For each merchant existing in the merchants database, the following information can be added, linked via a unique merchant identification code: a description by the merchant of the services offered in the shop, possibly in several languages, a description by a customer of his experience on a certain date and associated ratings, and average ratings and associated rankings;

040 A computer-readable storage medium comprising a specific data structure which contains information related to the merchants information communicated to the members as recommendations: hereafter the

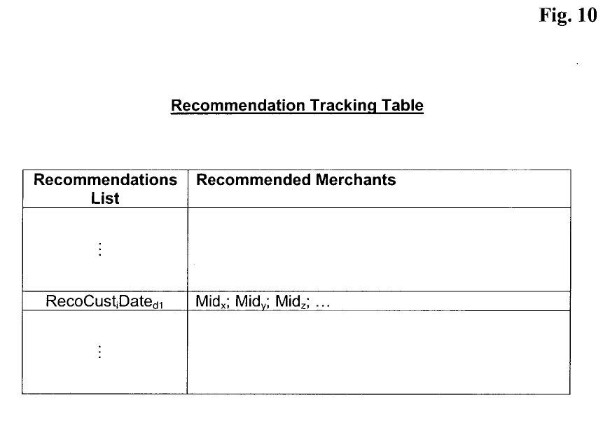

Recommendation Tracking Table (RTT) (FIG. 10) built and/or updated in processes B1 and B2.

For each recommendation, the following information is for example stored: a unique member (or relationship or account or payment tool) identification code, the date, a unique merchant identification code and additional information for the recommended merchants;

050 The Institution WEB server which links the institution and its Institution Global Data Structure 070 to the Internet, cell phones and other personal digital assistants;

060 The Customer Service server which provides Customer Service representatives and other staff with relevant information to answer queries from members and merchants, it is linked to or part of the Institution Main Data Structure 010;

070 The Institution Global Data Structure (IGDS) comprises at least the Institution Main Data Structure 010, the Similarity Table 020, the Merchant Information Table 030, the Recommendation Tracking Table 040, the Institution WEB server 050, the Customer Service server 060 and the process steps A, B, C, D, E, and F as described below, and can also include other data structures, processes, systems and storage media.

A subset of the information contained in the Institution Main Data Structure 010 (with possibly additional information from the Merchant Information Table 030) is used in process step A to compute similarities between merchants which information is stored in the Similarity Table 020. The built up of said Similarity Table can require some input of one or more experts or groups of authorized people, for example for fine tuning the similarity table.

The process step B1 uses information from the Institution Main Data Structure 010 including latest transactions to generate personal recommendations to be included with the statements sent to the members or to generate mailings or other outgoing communications, such as phone communications, e-mails (also sent to mobile phones and personal digital assistants), SMS, etc. (process step G).

The process step B2 is generated by a requester who wants to receive personal recommendations. The interactions with the Institution are made via the Internet and the Institution Web Server 050 and process step I or via a contact (process step H) with a customer representative which uses the Institution Customer Service Server 060 to fulfill the request. The latest transactions (obtained from the Institution Main Data Structure 010) and specific input from the requester are used to generate the recommendations.

Also during the process steps B1 and B2, the resulting information provided to the requester can be enhanced with information from the Merchant Information Table 030.

During the process steps B1 and B2, a Recommendation Tracking Table 040 is maintained which keeps tracks of the recommendations made to members. On a regular basis (monthly for instance) the information stored in this table is matched with new transactions (process step E). The results of this matching (the Successful Recommendation Table) can be used to adjust the computing, such as calculations, made in process step A or to communicate actual matches between recommendations and subsequent transactions to the merchants.

The process step F builds and updates the Merchant Information Table 030 from a subset of the Merchant Database in 010. The Merchant Information Table 030 is then enriched via the process steps C Enrichment of the Merchant Information Table, by the merchant himself or by members.

List and Brief Description of the Process Steps Appearing in FIG. 1:

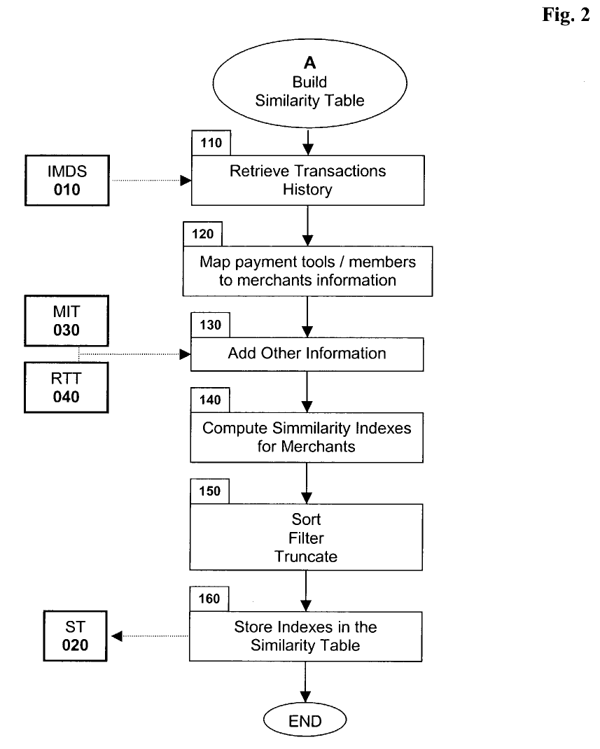

A: Build Similarity Table 020 (FIG. 2);

B: Generate personal recommendations lists or recommendation lists for a group of members and creates the Recommendation Tracking Table 040:

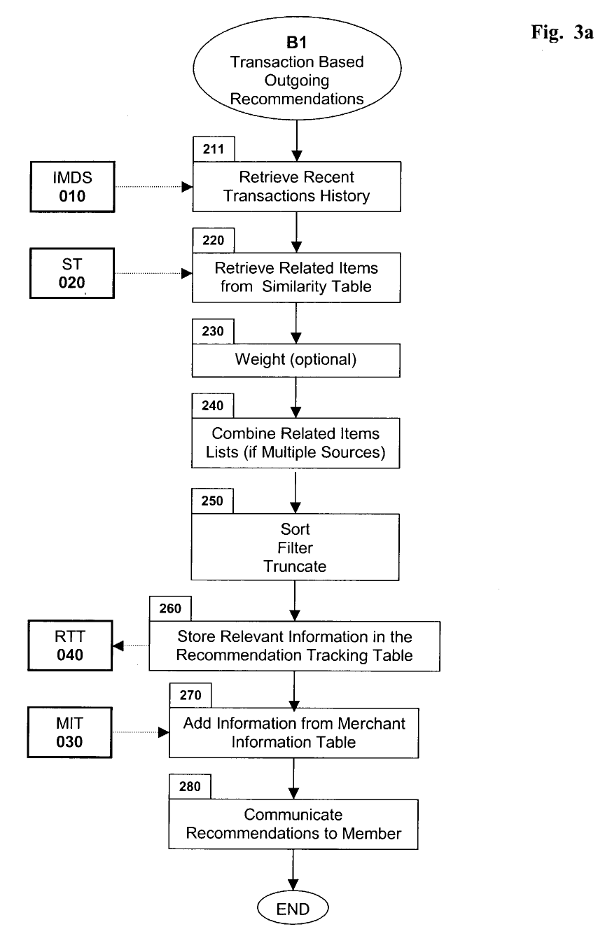

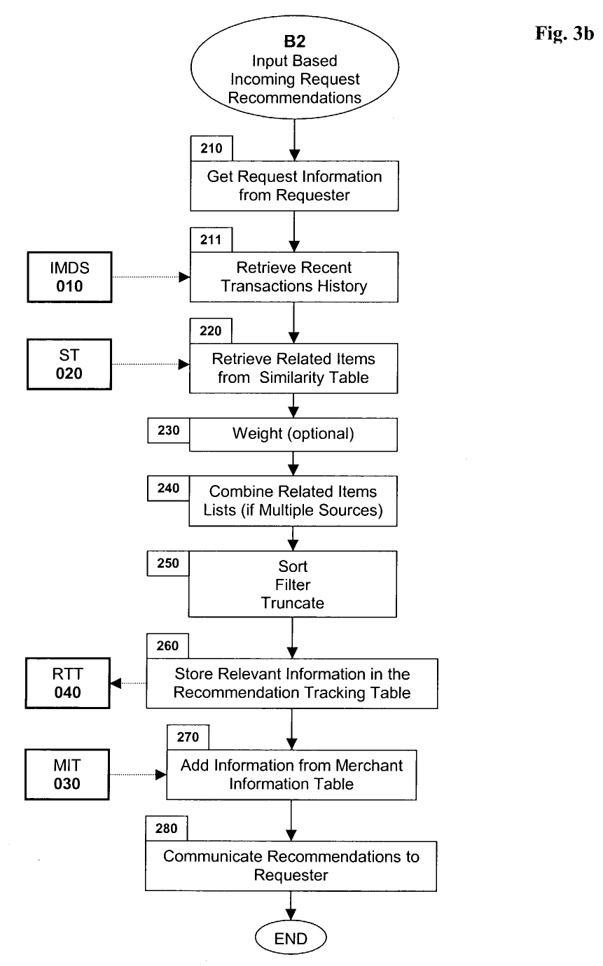

B1: Generated by the network's institution based on latest member's transactions (FIG. 3a);

B2: Request via Internet/phone/other communication tool based on latest member's transactions and/or on input from the member and/or a non-member (FIG. 3b);

C: Enrichment of the Merchants Information Table 030:

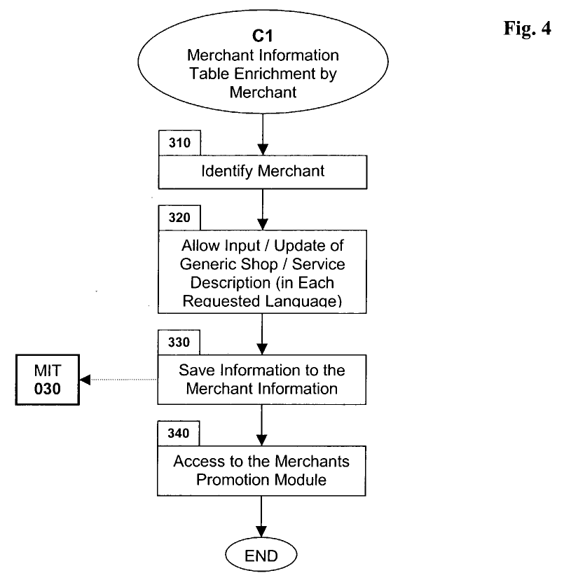

C1: By the merchant himself for his own shop (FIG. 4):

Input of a description of or generic information on the shop/service (possibility of multilingual input);

Input of promotions/menus/etc. (possibility multilingual) (the promotions module may have its own rules and promoting rules, that may be linked to the recommendation module);

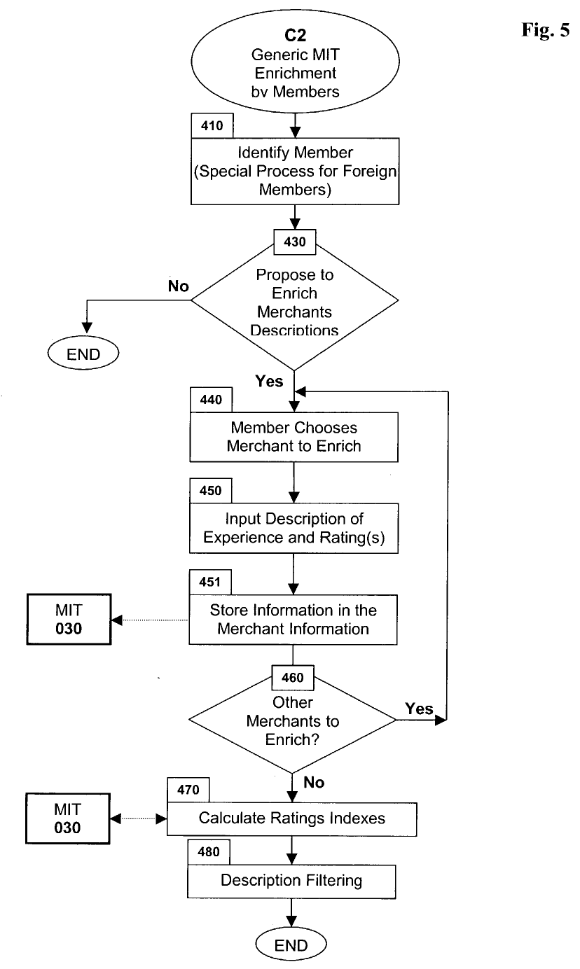

C2: By members (FIG. 5):

description of experience;

input of rating(s) (possibility of multiple ratings to analyze complexity of the service offered), these ratings can be averaged, analyzed in trend, used to rank shops, etc.);

C3: By one or more experts or authorized people, said expert(s) or authorized people can be used for enriching the database and/or for controlling the enrichment of said database made by members and/or merchants.

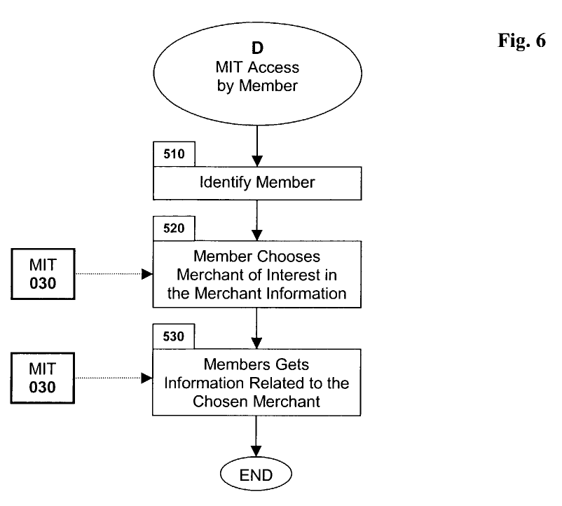

D: Access by members or group of members to the Merchants Information Table 030 for information (FIG. 6);

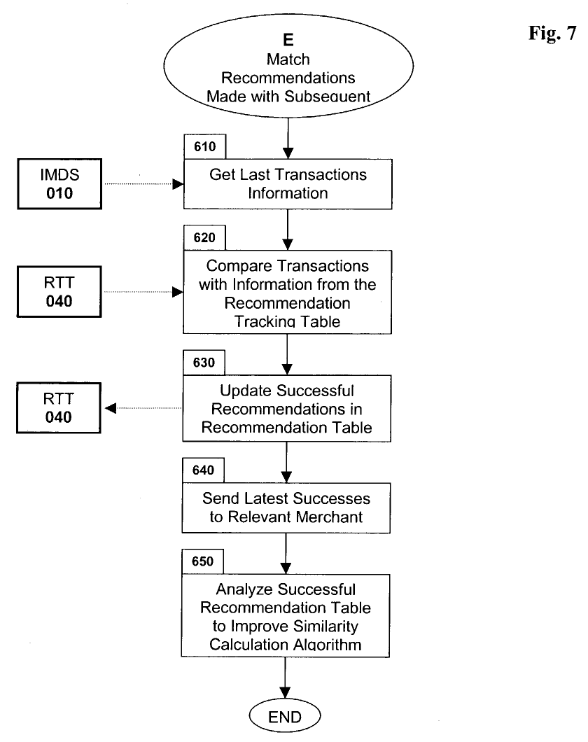

E: Analyze the matching of Recommendation Tracking Table 040 with respect to one or more subsequent transactions (FIG. 7):

The results can be used to improve the result of process A;

Communicate actual matches to merchants;

F: Download/update of necessary merchant information in the Merchants Information Table 030;

G: Outgoing communication process like statement processing (paper and/or Internet) and/or via mails, e-mails, and any other outgoing communication tool;

H: Customer interaction with an institution customer representative, can be via telephone, letter, email, etc.;

I: Customer access to the Institution Internet site and services via the Institution Web Server 050.

The process steps A, B, C, D, E, and F can be carried by one or several computers possibly connected by any means such as a local area network or wide area network.

Each process step A to I is a further subject matter of the invention. These process steps will now further be described.

A particular embodiment of the process step A for building the Similarity Table in a computer-readable storage medium comprising a specific similarity data structure is shown in FIG. 2.

First the network transactions history or advantageously a subset in time thereof is retrieved (110) from the Institution Main Data Structure (IMDS) 010.

Then this transaction information, which can consist of the Boolean value existence of transaction(s), number of transactions, the volume of all transactions at a merchant, the volume of each transaction, the average volume of the transactions, the date and/or the time of each transaction, and/or any other useful available transaction information, is mapped (120) in a specific data structure attached or connected to a merchants table, which is for example issued and/or derived from the Institution Main Data Structure 010.

In 130 additional information is retrieved from 010, from 030, and possibly from one or more other available sources like merchants information, recommendations tracking table RTT 040, successful recommendations, payment tools characteristics, users information, users' ratings of merchants, external ratings of merchants, users behavior, payment tools behavior, accounts behavior, and relationships behavior, is mapped (130) against the merchants table in a specific data structure attached or connected to the merchants table.

The application or step 140 computes similarity indexes for the merchants from the data structure mapped in step 130. Said computing step, possibly with expert control and/or expert input, edits a specific similarity data structure which maps items from a database of merchants to sets of similar items from the database of merchants. In a preferred embodiment, a table of similarity factors with the other merchants is determined or calculated for each affiliated merchant (or the major ones); each similarity factor represents a degree of correlation between the fact that members that go to the first merchant go to the second one. Regardless of the method used to generate the similarity factors, each index value indicates a degree of similarity between two items, they are used to select a plurality of merchants that have a high degree of correlation to a merchant.

Then in 150 the resulting merchants table can be sorted, possibly (but advantageously) filtered (for instance certain types of merchants which the network does not want to publicize can be excluded at this stage), and possibly (but advantageously) truncated (if only merchants similarities above a certain threshold are to be kept), before the similarity indexes are stored into the Similarity Table ST 020.

The Similarity Table ST 020 is advantageously stored in step 160 in a computer readable form, such as a computer-readable storage medium comprising a specific similarity data structure which maps items from the institution main data structure database of merchants to sets of similar items from the institution main data structure database of merchants including items similarity index values, each index value indicating a degree of similarity between two items based on at least one set of information selected from the group consisting of transactions information, merchants information, successful recommendations, payment tools characteristics, users information, users' ratings of merchants, external ratings of merchants, users behavior, payment tools behavior, accounts behavior, relationships behavior, and combinations thereof.

Two particular embodiments of the process step B for generating personal recommendations to users are provided in FIG. 3a and FIG. 3b. In the two embodiments the recommendation process is based on using the Similarity Table ST 020 created in process step A.

In a particular embodiment (FIG. 3b, process step B2), the personal recommendations process is initiated by a member of the network or a user of the system based on (a recent subset of) transactions of members from the member's transactions history; the member's payment tools transactions history, the member's accounts transactions history, the member's relationships transactions history, and/or a specific list of affiliated merchant chosen by the requester and/or specific restrictions (locations, type, etc.). The process 210 gets the input of reference merchants and possible restrictions from the requester.

In another embodiment (FIG. 3a, process step B1), the personal recommendations process or the recommendations process for a group of members can be initiated by the institution based on (advantageously a recent subset of) transactions of members from the member's transactions history; the member's payment tools transactions history, the member's accounts transactions history, the member's relationships transactions history.

After the initial treatment step 210 in the process step B2, the next steps are similar for both process steps B1 and B2. First, the process 211 retrieves (a recent subset of) the member's transactions history and/or the member's payment tools transactions history and/or the member's accounts transactions history and/or the member's relationships transactions history including the merchant information, i.e. from data issuing from the Institution Main Data structure 010.

In 220 for each transaction or for each merchant generated in 210 and 211, the related information is retrieved from the Similarity Table 020. In 230 this information can then be weighted based for instance on the number of appearances, and/or the number of transactions and/or the value of transactions and/or the moment of the transaction and/or the value of similarity indexes and/or the user's communicated restrictions and/or the users' rating of merchants and/or external ratings of merchants and/or the location and/or facilities. In 240 the information from the step 220 possibly weighted in step 230 is then combined into one list, in case information are issued from multiple source items.

In 250 the list can be sorted, possibly (however advantageously) filtered, for instance certain types of merchants which the network does not want to publicize for one or another reason, such as moral reason, can be excluded at this stage if not before, this can also be based on the requester's expressed preferences; another filtering process can be carried out by using information from the user's payment tools past or current behavior and/or the user's payment tools past or current location. Then the list can be truncated or ranked if only merchants above a certain threshold or a maximum number of merchants are to be kept, or based on the available communication space. Such a truncation or ranking is however preferred, so as to edit a list of ranked similar merchants or a ranked set of similar merchants.

In 260 the recommendations information is saved to the Recommendation Tracking Table RTT 040 for future use. Then additional information from the Merchant Information Table MIT 030 like ratings and other members' comments can be added in 270 to the recommendation information of step 250. Possibly said additional information can also be stored in a Recommendation Tracking Table RTT 040. In the latter case, the step 260 is advantageously carried out after the step 270.

The final stage of the process steps B1 or B2 is 280 to communicate the resulting recommendations list (being information related to the merchants such as name, address, e-mail, phone, etc.) or part thereof to the member or the requester or to the group of members.

A particular embodiment of the process step C1 for the merchant to enrich information about his shop and/or service in the Merchant Information Table is shown in FIG. 4.

First in 310 the merchant accesses the WEB server 050 of the institution, is identified and access its account. In case the merchant is not provided with an adequate web server connection, the merchant can have access to authorized people of the institution, so as to be able to continue the process. Then in 320 the merchant can input and update descriptions about his services (for instance for a restaurant the owner would input once a brief description of the place, the type of cuisine, the atmosphere, and regularly an update of the carte and specific menus), this in several languages if he wills. If translations are required, the institution global structure can be provided with one or more translators and/or with one or more connections to one or more translation systems, such as automatic translation systems. This information is saved into the Merchant information Table MIT 030 in step 330. A next step can be access to a promotion module 340 that would allow for promotions and discounts to be communicated to members.

A particular embodiment of the process step C2 for the members to provide information about their experience with shops and/or services in the Merchant Information Table is shown in FIG. 5, i.e. for enriching the merchant information table MIT 030.

First in 410 the member is identified, this can be part of an overall identification process for instance when entering the “private” part of the Internet site on the institution's WEB server 050. A specific process can be created to check the existence of “foreign” members (being members of another institution). Possibly, the merchant information table MIT 030 can be enriched with information from members from one or more institutions, and with distinct information from non members of said institution(s). After the member has chosen to enrich merchants in 430, the member chooses which merchant he wants to enrich in 440, then in 450 the member input a description of the experience and related ratings, information which is then stored into the Merchant Information Table 030 in 451. In 460 the member is asked if he wants to continue to input experiences, if yes then the member continues in 440. Otherwise 470 re-determines or recalculates the indexes (averages, ranking, etc.) (can be performed on-line or batch). And to avoid defamation issues a filtering 480 of the inputs can be performed, based on keywords and on low rating(s) inputs (although there is an identification process which should minimize issues). Said filtering can be operated by experts or authorized people of the institution or designed by the institution.

The step 430 is advantageously provided with instruction to stop or end the process C2 when no merchant(s) have to be enriched by the member or non member.

A particular embodiment of the process step D for the members to access the information in the Merchant Information Table 030 is shown in FIG. 6.

First in 510 the member is identified, this can be part of an overall identification process for instance when entering the “private” part of the Internet site on the institution's WEB server 050. A specific process can be created to check the existence of “foreign” members (being members of another institution). It can also be decided to let this information be public, at least partially.

Then in 520 the member chooses from the table 030 which merchant is of interest to him, and gets in 530 the information related to this merchant like location (including a map), all input by the merchant plus specific information by the members (like the last descriptions of experience) and average ratings and rankings. This process 530 can also be part of the process step 280, for instance when the request has been performed via Internet.

A particular embodiment of the process step E for matching the recommendations that were made to members with actual subsequent transactions is shown in FIG. 7.

In a computer-readable storage medium comprising a specific recommendation tracking data structure (the Recommendation Tracking Table 040) which contains information about the recommendations of merchants made to the users. The most recent transactions (since the last time this process has been run) 610 obtained from the Institution main data structure 010 are matched in 620 with the information available in the Recommendation Tracking Table RTT 040, which is enriched with successful recommendation information 630. The successful recommendation information are in this manner entered in the RTT database 040.

Successful recommendations are recommendations that are followed within a selected timeframe by a transaction at the merchant on the member's payment tools and/or the user's accounts and/or the user's relationship.

These successful recommendations can be used to be sent to the relevant merchant at which the successful transaction happened to promote the process and the network 640. In another embodiment they can be accessed by the merchant via the WEB server 050.

They can also be used to improve the similarity indexes calculation algorithm 650.

In another embodiment, the process steps A and B differ with the members being classified into communities or clusters of alike.

First the network transactions history or advantageously a subset in time thereof is retrieved from the Institution Main Data Structure IMDS 010. Then this transaction information, which can consist of the Boolean value existence of transaction(s), number of transactions, the volume of all transactions at a merchant, the volume of each transaction, the average volume of the transactions, the date of each transaction, the time of the day of each transaction, and any other useful available transaction information, is mapped in a specific data structure attached or connected to a merchant table, which is for example issued and/or derived from the Institution Main Data Structure IMDS 010

Additional information is retrieved from the Institution Main Data Structure IMDS 010, from MIT 030, and possibly from one or more other available sources like merchants information, Recommendation Tracking Table RTT 040, payment tools characteristics, users information, users' ratings of merchants, external ratings of merchants, users behavior, payment tools behavior, accounts behavior, and relationships behavior, is mapped against the members table in a specific data structure attached or connected to the merchant table.

The application computes similarity indexes for the members in a specific similarity data structure which maps items from a database of members to sets of similar items from the database of members. In a preferred embodiment, a table of similarity factors with the other members is determined or calculated for each members (or the major spenders or any other definition); each similarity factor represents a degree of correlation between the fact that members that go to the first merchant go to the second one. Regardless of the method used to generate the similarity factors, each index value indicates a degree of similarity between two items, they are used to select a plurality of members that have a high degree of correlation together.

Then the resulting members table can be sorted, possibly (but advantageously) filtered (for instance certain communities of members which the network does not want to promote can be excluded at this stage), and possibly (but advantageously) truncated (if only members similarities above a certain threshold are to be kept), before the similarity indexes being stored into a Community Table.

The process step B is then based on this Community Table, which classifies the members into communities or clusters of alike.

The personal recommendations process can be initiated by the institution or a member of the network and specific restrictions (locations, type, etc.) can be added by the member.

First but optional the restrictions are obtained from the member. Then the community table is accessed to identify other members belonging to the same community. For each member of the community, associated merchants are identified, for instance from (advantageously a recent subset of) transactions and/or member's ratings input.

The information is then combined into one list in case of multiple source items, then weighted based for instance the number of appearance of a merchant and/or the number of transactions with a merchant and/or the value of the transactions and/or the time of the transactions and/or the value of similarity indexes between members, and/or the user's communicated restrictions, and/or the users' rating of merchants, and/or external ratings of merchants.

The list can be possibly (but advantageously) sorted, then filtered, for instance certain types of merchants which the network does not want to publicize can be excluded at this stage if not before, this can also be based on the user's expressed preferences; another filtering process can be carried out using a function of the member's payment tools past or current behavior and/or the member 's payment tools past or current location.

The list can be possibly (but advantageously) truncated if only merchants above a certain threshold or a maximum number of merchants are to be kept, or based on the available communication space. The recommendations information is saved to a Recommendation Tracking Table for future use. Additional information from a Merchant Information Table like ratings and other members' comments can be added. The final stage of the process is to communicate the resulting recommendations list (being information related to the merchants), via the statements or via the member's preferred communication tool.

When using communities of members, it is possible to establish the recommendation table in function of data in the Institution Main Data Structure IMDS relating to one or a plurality of members of said community, for example selected as being well representative of the community.

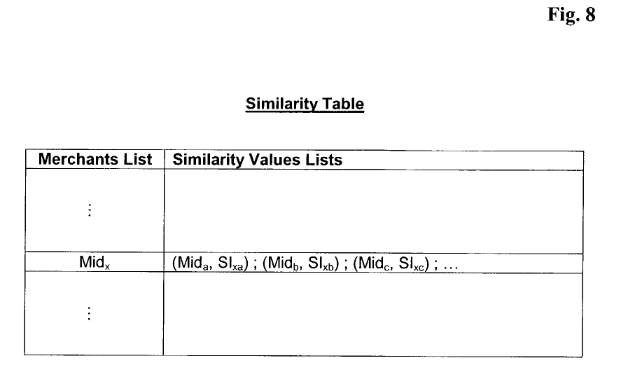

FIG. 8 is a schematic view of a possible Similarity Table ST 020. Said table comprises a column with the different merchants (as per full merchants database or a subset), each merchant being identified by a unique Merchant Identification Code, i.e. Midᵢ for merchant “i”, where “i” can vary for example from 1 to n if that is the case in the merchant database. To each listed merchant (for example merchant Midᵢ), a list of merchants and similarity values is attached, said list giving the similarity index between merchant Midᵢ and other merchant Midⱼ, with j possibly varying from 1 to n. Most likely the attached merchants and similarity values will only be for similarity values above a certain cut-off to limit the amount of information kept in the table. The table is also symmetrical: the similarity value between Midᵢ and Midⱼ is the same as the similarity value between Midⱼ and Midᵢ.

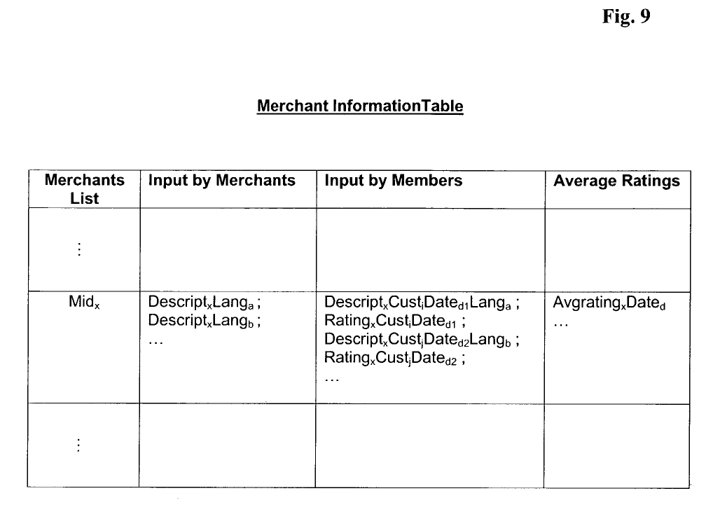

FIG. 9 shows schematically a Merchant Information Table, having for example three columns, namely a Merchant list, a list with input by merchants, a list with input by members, and calculated averaged ratings. The Merchants are each identified with a unique Merchant Identification Code, namely Midₓ for Merchant x.

The input made by merchants is for example a description by merchant x of the services offered in his shop or office, for example in the language a, namely DescriptₓLangₐ, then DescriptₓLang_{b} in language b, etc. In case the Institution main data structure is provided with a translator or with means for connecting to an external translator, such as an automatic translator, the input can be made in one language then translated into other languages.

The input by members is for example one or more information selected from the group consisting of:

description made by customer “i” of his experience on date “d” with merchant x, in a language a, namely DescriptₓCustᵢDate_{d}Langₐ

rating given by customer “i” of his experience on date “d” with merchant x, namely RatingₓCustᵢDate_{d}

The average rating for merchant x, as of date “d”, namely AvgratingₓDate_{d}, said average is calculated in function of the members' rating(s) input and can be weighted on basis of one or more factors or parameters, such as amounts of transactions made by Customer “i”, the number of transactions made by customers at merchant “x”, etc., or a combination of such parameters.

An example of recommendation tracking table is given in FIG. 10. Said table comprises a column with identification code of recommendation made on date “d” to customer “I”, namely RecoCustᵢDate_{d}, and a column for listing the Merchant Identification code of all the merchants being recommended to customer “i” on date “d” (Midₓ, Mid_{y}, Mid₂, etc.).

Example of a Simplified Possible Working of a Preferred Embodiment

In the implementation described below the institution manages a closed-loop payment network in a small town, offering payment tools and merchant acceptance in this territory. The institution has adopted a specific version of the invention. Information non-specifically related to the invention will be described only to the extend necessary to the comprehension of the description.

The description purpose is to describe a specific embodiment of the invention via the processes and actions occurring during “period 1” and “period 2”, and not to limit the scope of the invention.

Payment Tools

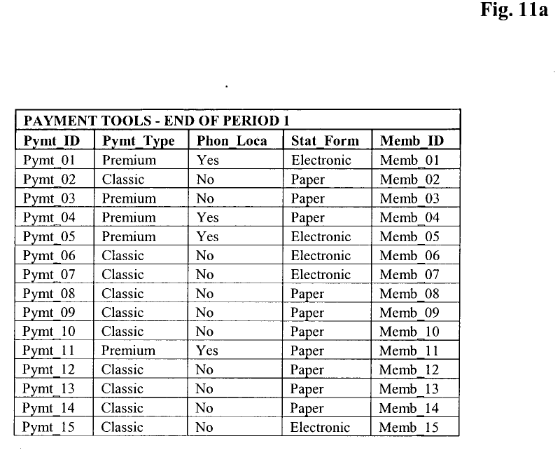

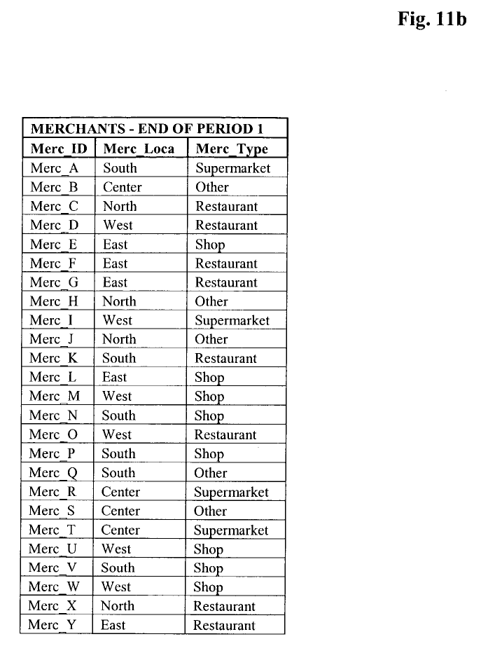

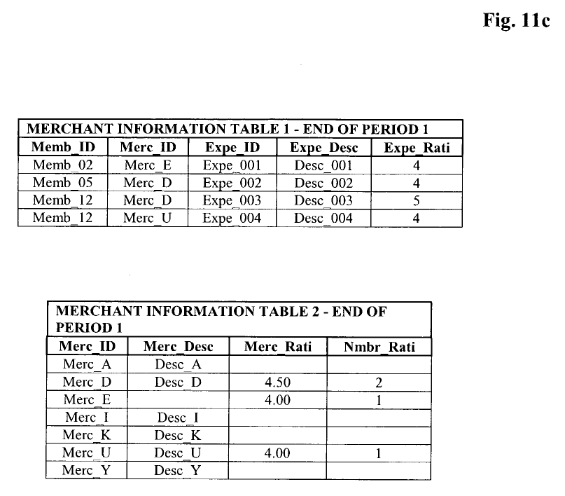

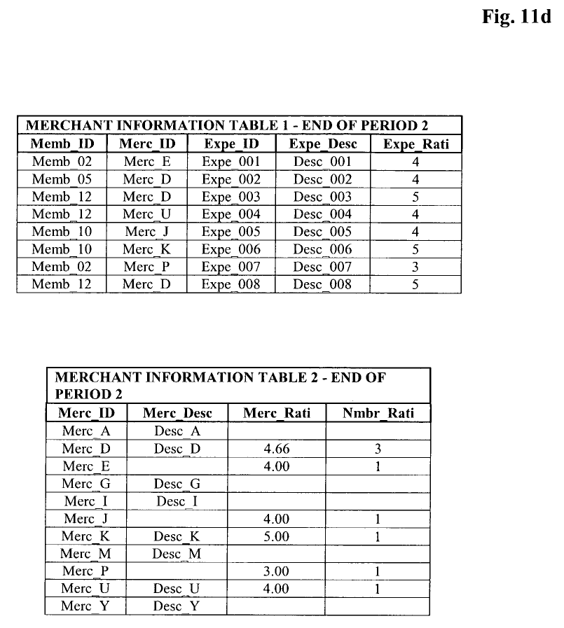

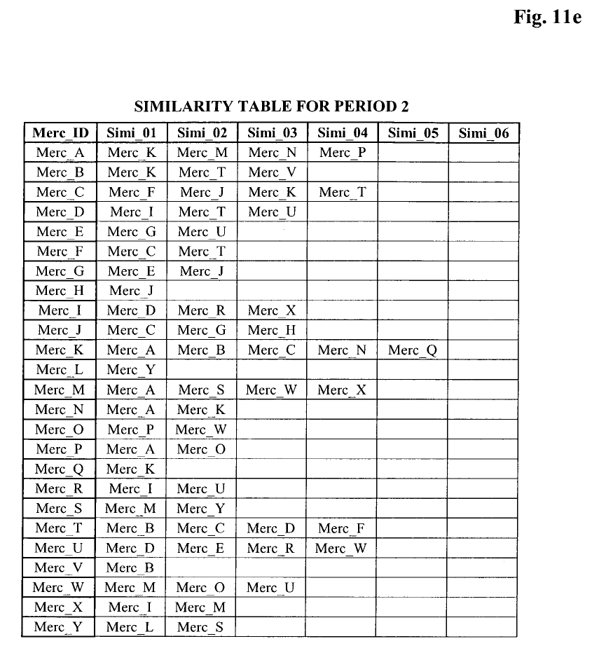

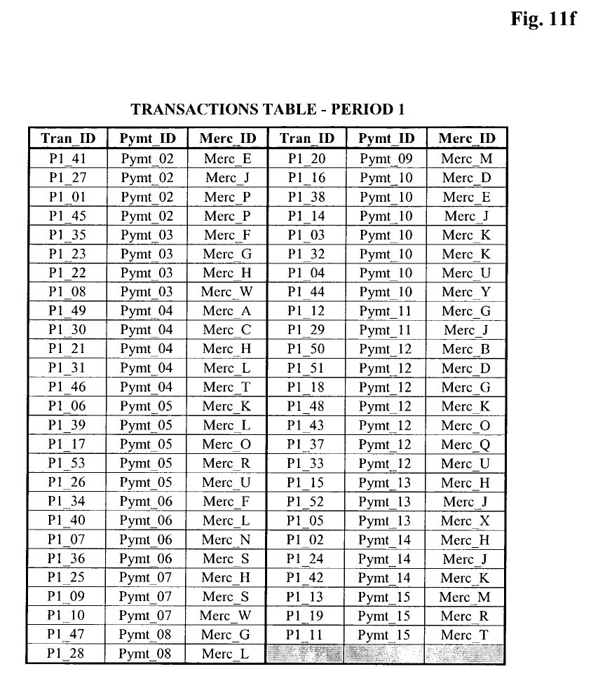

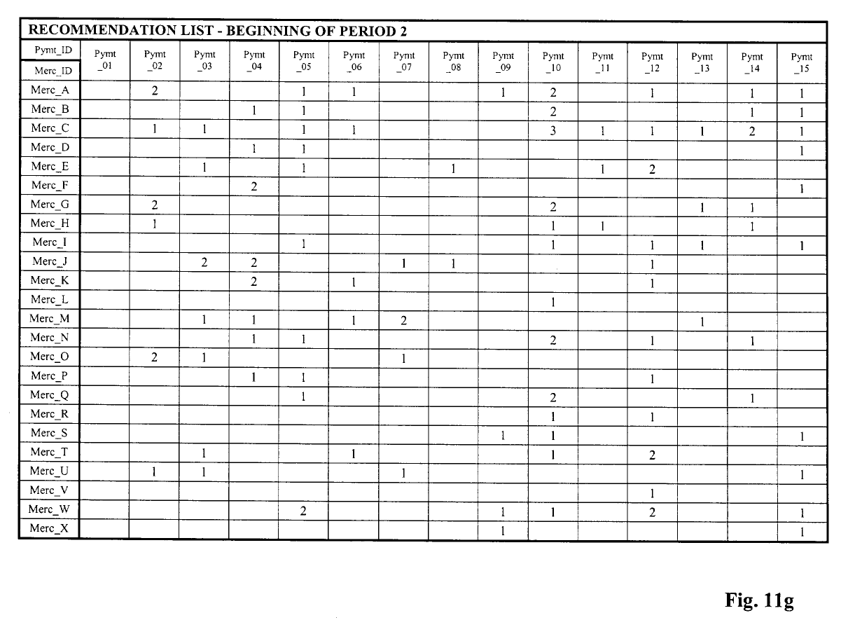

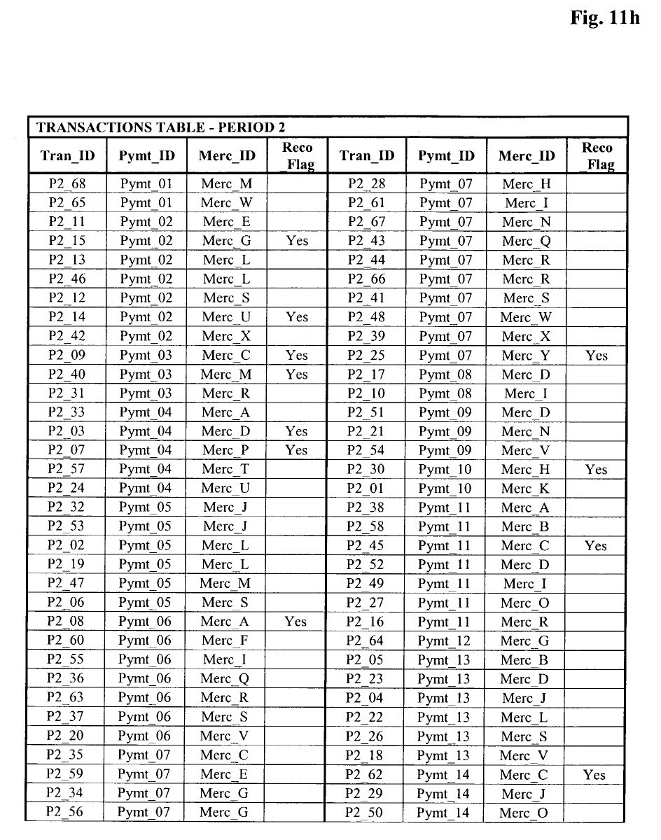

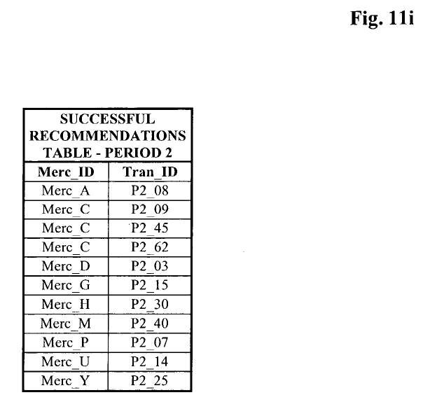

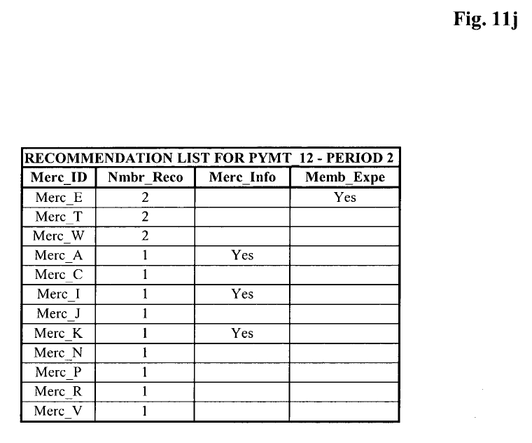

The institution offers two types of products, “Classic” or “Premium”. The Premium product offers some additional features, including the possibility for the payment tool to be linked to a cellular phone which within others can provide the institution with information on the current location of the member. Another choice for the member is to receive the billing information via normal mail or to receive an e-mail notifying of the information availability on the institution Web server. At the end of period 1, the institution has issued 15 payment tools (from Pymt_{—}01 to Pymt_{—}15), each belonging to a different member (from Memb_{—}01 to Memb_{—}15), as per the Payment Tools Table at the end of period 1 shown in FIG. 11a:

Pymt_ID: a unique identification number for the payment tool

Pymt_Type: the type of the product, choice between “Classic” and “Premium”

Phon_Loca: is the payment tool linked to a cellular phone?

Stat_Form: format of the statements, to be received by classic paper mail (“Paper”) or to be available on the institution Web server (“Electronic”)?

Memb_ID: a unique identification number for the member who owns the payment tool.

Other information (like addresses, etc.) is not shown.

Members

The information about the 15 members (like name, date of birth, etc.) is not shown.

Merchants

At the end of period 1, the institution has licensed 25 merchants which are classified in 4 types: “Restaurant”, “Shop”, “Supermarket”, and “Other”. The town is also divided in 5 districts: “North”, “East”, “South”, “West”, and “Center”. See the Merchant Table at the end of period 1 in FIG. 11b:

Merc_ID: a unique identification number for the merchant

Merc_Loca: in which district of the town is the merchant located?

Merc_Type: which type is the merchant?

Other information (like names and addresses, etc.) is not shown.

FIG. 11c shows the Merchant Information Tables at the end of period 1. The Merchant Information Table 1 contains additional information arising from individual enrichments by the members about their experience at a merchant:

Memb_ID: a unique identification number for the member who has provided the information

Merc_ID: a unique identification number for the merchant where the experience happened

Expe_ID: a unique identification number for the experience

Expe_Desc: description by the member of his experience at the merchant

Expe_Rati: rating associated with the experience, from 1 (bad) to 5 (excellent)

Other information (like language, date, etc.) is not shown.

The Merchant Information Table 2 contains additional information about merchants which has been input by the merchant itself, and the average of the ratings input by the members:

Merc_ID: a unique identification number for the merchant

Merc_Desc: input by a merchant of a description of his shop

Merc_Rati: average of the experience ratings entered by the members

Nmbr_Rati: number of experience ratings entered by the members

Other information (like date and language, etc.) is not shown.

Similarity Table

The Similarity Table utilized by this institution is a simple one with the similarity index taking Boolean values. FIG. 11e shows the Similarity Table computed at the beginning of period 1 and expected to be used during 3 periods.

Merc_ID: a unique identification number for the merchant

Simi_{—}01: the Merc_ID of the first (alphabetical order as Boolean value) merchant computed similar to the merchant shown in Merc_ID

Simi_{—}02: the Merc_ID of the second merchant computed similar to the merchant shown in Merc_ID

Simi_{—}03: the Merc_ID of the third merchant computed similar to the merchant shown in Merc_ID

Simi_{—}04: the Merc_ID of the fourth merchant computed similar to the merchant shown in Merc_ID

Simi_{—}05: the Merc_ID of the fifth merchant computed similar to the merchant shown in Merc_ID

Simi_{—}06: the Merc_ID of the sixth merchant computed similar to the merchant shown in Merc_ID

Transactions Period 1

During the period 1, 53 transactions have been completed at merchants, see the Transaction Table shown in FIG. 11f (ordered by Pymt_ID):

Tran_ID: a unique identification number for the transaction

Pymt_ID: a unique identification number for the payment tool

Merc_ID: a unique identification number for the merchant

Other information (like amount of the transaction, date and time, etc.) is not shown.

End of Period 1

At the end of period 1 the billing cycle closing is performed, when all transactions of the period 1 are billed to the members.

Recommendation List

At the same moment, based on the transactions of the month and on the Similarity Table are created the Recommendation Lists for each payment tool. FIG. 11g shows a table summarizing the Recommendation Lists for all payment tools:

Pymt_ID: a unique identification number for the payment tool

Merc_ID: a unique identification number for the merchant

The Recommendation List is created by building a list of all merchants defined similar (in the Similarity Table) to a merchant where the member transacted during the period 1. In the table shown in FIG. 11g, the information shown for each pair of member/merchant is the number of times the merchant is appears.

For all payment tools which should receive their billing information via paper, the transactions of the previous period and the related recommendations are provided with the necessary information (member name, payment tool number and address) to a mailing house (which can be in-house) which will print and dispatch the information. For the other payment tools, the transactions of the previous period and the related recommendations are posted on the secured part of the institution Web server and an e-mail is send at the defined e-address to warn about their accessibility. This e-mail will include the recommendations, which are also accessible on the secure part of the Web server.

The recommendations will be ordered by frequency of apparition in the Recommendation List and additional information will appear like address, but also the availability of supplementary information on the institution Web server. FIG. 11j shows for example the recommendations that are made to Pymt_{—}12 for period 2:

Merc_ID: a unique identification number for the merchant

Nmbr_Reco: number of times the merchant has shown up in as recommendation, is used to order the recommendations and to strengthen their validity

Merc_Info: availability of additional information on the merchant on the institution Web server

Memb_Expe: availability of additional information on the merchant on the institution Web server

Other information (like address, telephone, etc.) is not shown.

Also during the period, if the payment tool is linked to a cell phone indicating the location, recommendations can be made based on a matching between the payment tool Recommendation List and on the cell phone actual location.

Each member can also access his payment tools recommendations on the institution Web server.

Period 2

FIG. 11d shows the Merchant Information Tables at the end of period 2: Four new experiences and related ratings (Expe_{—}005 to Expe_{—}008) were added to the Merchant Information Table 1, this also impacts the average ratings in Merchant Information Table 2. And two new merchants (Merc_G and Merc_M) entered additional information about their place in Merchant Information Table 2.

FIG. 11h shows the 68 transactions that were performed during period 2:

Tran_ID: a unique identification number for the transaction

Pymt_ID: a unique identification number for the payment tool

Merc_ID: a unique identification number for the merchant

Reco_Flag: show “Yes” if the merchant has been recently (here in the period) recommended to the member who owns the payment tool

Other information (like amount of the transaction, date and time, etc.) is not shown.

Therefore 11 transactions correspond to former recommendations, separately shown in FIG. 11i:

Merc_ID: a unique identification number for the merchant

Tran_ID: a unique identification number for the transaction

Other information (like amount of the transaction, date and time, etc.) is not shown.

These transactions and/or information relating thereto can be communicated to the merchants, to promote the process and the network.

What is claimed is:

1. In a computer system containing information related to at least one financial transaction network in a specific institution main data structure, a system for providing information on merchants to users, comprising:
a computer-readable storage medium comprising a similarity data structure which maps items from the institution main data structure database of merchants, to sets of similar items from the institution main data structure database of merchants including items similarity index values, each similarity index value indicating a degree of similarity between two items; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof; and
(d) communicating to the user information related to at least some of the merchants of the ranked set of similar merchants.

2. The system of claim 1 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

3. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof, and
(d) communicating to the user information related to at least some of the merchants of the ranked set of similar merchants as recommendations;
a computer-readable storage medium comprising a specific recommendation tracking data structure which contains information about the recommendations of merchants made to the users; and
a computer system to compare part of the information in the recommendation tracking data structure with part of the information contained in the institution main data structure for at least:
(e) communicating to the merchants the recommendations that were made to users that have been followed within a selected timeframe by a transaction at the merchant for at least one set selected from the group consisting of the user's payment tools, the user's accounts, the user's relationship, and combinations thereof, being successful recommendations; and
(f) offering to the merchants access to a list of successful recommendations at the merchant.

4. The system of claim 3 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

5. In a computer system containing information related to at least one financial transaction network in a specific institution main data structure, a system for enriching information related to merchants, comprising:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

6. In a computer system containing information related to at least one financial transaction network in a specific institution main data structure and a system for generating recommendations of merchants to users, a system for tracking successful recommendations comprising:
a computer-readable storage medium comprising a specific recommendation tracking data structure which contains information about the recommendations of merchants made to the users; and
a computer system to compare part of the information in the recommendation tracking data structure with part of the information contained in the institution main data structure for at least:
(a) communicating to the merchants the recommendations that were made to users that have been followed within a selected timeframe by a transaction at the merchant for at least one action selected from the group consisting of the user's payment tools, the user's accounts, the user's relationship, and combinations thereof, being successful recommendations; and
(b) offering to the merchants access to a list of successful recommendations at the merchant.

7. In a computer system containing information related to at least one financial transaction network in a specific institution main data structure, a system for providing information on merchants to users, comprising:
a computer-readable storage medium comprising a specific similarity data structure which maps items from the institution main data structure database of merchants to sets of similar items from the institution main data structure database of merchants including items similarity index values, each index value indicating a degree of similarity between two items based on at least one set of information selected from the group consisting of transactions information, merchants information, successful recommendations, payment tools characteristics, users information, users' ratings of merchants, external ratings of merchants, users behavior, payment tools behavior, accounts behavior, relationships behavior, and combinations thereof; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof; and
(d) communicating to the user information related to at least some of the merchants of the ranked set of similar merchants.

8. The system of claim 7 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

9. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items based on at least one set of information selected from the group consisting of transactions information, merchants information, successful recommendations, payment tools characteristics, users information, users' ratings of merchants, external ratings of merchants, users behavior, payment tools behavior, accounts behavior, relationships behavior, and combinations thereof; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof; and
(d) communicating to the user information related to at least some of the merchants of the ranked set of similar merchants as recommendations;
a computer-readable storage medium comprising a specific recommendation tracking data structure which contains information about the recommendations of merchants made to the users; and
a computer system to compare part of the information in the recommendation tracking data structure with part of the information contained in the institution main data structure for at least:
(e) communicating to the merchants the recommendations that were made to users that have been followed within a selected timeframe by a transaction at the merchant for at least one set selected from the group consisting of the user's payment tools, the user's accounts, the user's relationship, and combinations thereof, being successful recommendations; and
(f) offering to the merchants access to a list of successful recommendations at the merchant.

10. The system of claim 9 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

11. In a computer system containing information related to at least one financial transaction network in a specific institution main data structure, a system for providing information on merchants to members, comprising:
a computer-readable storage medium comprising a community data structure which maps items from the institution main data structure database of members to sets of similar items from the institution main data structure database of members including items similarity index values, each index value indicating a degree of similarity between two items; and
a computer system for recommendation process which generates personalized recommendations to members by at least:
(a) accessing the community data structure to identify a corresponding set of similar members;
(b) for each member identified in step (a), identifying a set of associated merchants;
(c) combining the sets of merchants identified in step (b) to generate a ranked set of merchants in which the merchants are weighted by at least a function of at least a parameter selected from the group consisting of a constant, the number of appearances, the number of transactions, the value of transactions, the moment of the transactions, the value of the similarity indexes, the user's communicated restrictions, the users' rating of merchants, external ratings of merchants, and combinations thereof; and
(d) communicating to the member information related to at least some of the merchants of the ranked set of similar merchants.

12. The system of claim 11 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

13. In a computer system containing information related to at least one financial transaction network in a specific institution main data structure, a system for providing information on merchants to members, comprising:
a computer-readable storage medium comprising a specific community data structure which maps items from the institution main data structure database of members to sets of similar items from the institution main data structure database of members including items similarity index values, each index value indicating a degree of similarity between two items; and
a computer system for recommendation process which generates personalized recommendations to members by at least:
(a) accessing the community data structure to identify a corresponding set of similar members;
(b) for each member identified in step (a), identifying a set of associated merchants;
(c) combining the sets of merchants identified in step (b) to generate a ranked set of merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof; and
(d) communicating to the member information related to at least some of the merchants of the ranked set of similar merchants as recommendations;
a computer-readable storage medium comprising a specific recommendation tracking data structure which contains information about the recommendations of merchants made to the members; and
a computer system to compare part of the information in the recommendation tracking data structure with part of the information contained in the institution main data structure for at least:
(e) communicating to the merchants the recommendations that were made to members that have been followed within a selected timeframe by a transaction at the merchant for at least one set selected from the group consisting of the member's payment tools, the member's accounts, the member's relationship, and combinations thereof, being successful recommendations; and
(f) offering to the merchants access to a list of successful recommendations at the merchant.

14. The system of claim 13 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

15. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the user's payment tools behavior, the user's payment tools location, and combinations thereof; and
(e) communicating to the user information related to at least some of the merchants of the subgroup of the ranked set of similar merchants.

16. The system of claim 15 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

17. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the user's payment tools behavior, the user's payment tools location, and combinations thereof; and
(e) communicating to the user information related to at least some of the merchants of the subgroup of the ranked set of similar merchants as recommendations;
a computer-readable storage medium comprising a specific recommendation tracking data structure which contains information about the recommendations of merchants made to the users; and
a computer system to compare part of the information in the recommendation tracking data structure with part of the information contained in the institution main data structure for at least:
(f) communicating to the merchants the recommendations that were made to users that have been followed within a selected timeframe by a transaction at the merchant for at least one set selected from the group consisting of the user's payment tools, the user's accounts, the user's relationship, and combinations thereof, being successful recommendations; and
(g) offering to the merchants access to a list of successful recommendations at the merchant.

18. The system of claim 17 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

19. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items based on at least one set of information selected from the group consisting of transactions information, merchants information, successful recommendations, payment tools characteristics, users information, users' ratings of merchants, external ratings of merchants, users behavior, payment tools behavior, accounts behavior, relationships behavior, and combinations thereof; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the user's payment tools behavior, the user's payment tools location, and combinations thereof; and
(e) communicating to the user information related to at least some of the merchants of the subgroup of the ranked set of similar merchants.

20. The system of claim 19 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

21. In a computer system containing information related to at least one financial transaction network in a specific institution main data structure, a system for providing information on merchants to users, comprising:
a computer-readable storage medium comprising a similarity data structure which maps items from the institution main data structure database of merchants to sets of similar items from the institution main data structure database of merchants including items similarity index values, each index value indicating a degree of similarity between two items based on at least one set of information selected from the group consisting of transactions information, merchants information, successful recommendations, payment tools characteristics, users information, users' ratings of merchants, external ratings of merchants, users behavior, payment tools behavior, accounts behavior, relationships behavior, and combinations thereof; and
a computer system for recommendation process which generates personalized recommendations to users selected from the group consisting of members and non-members, by at least:
(a) identifying a plurality of merchants from at least one set of information selected from the group consisting of a subset of the user's transactions history; a subset of the user's payment tools transactions history, a subset of the user's accounts transactions history, a subset of the user's relationships transactions history, the input of reference merchants by the user, and combinations thereof;
(b) for each merchant identified in step (a), accessing the similarity data structure to identify a corresponding set of similar merchants, thereby identifying a plurality of sets of similar merchants;
(c) combining the sets of similar merchants identified in step (b) to generate a ranked set of similar merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the user's payment tools behavior, the user's payment tools location, and combinations thereof; and
(e) communicating to the user information related to at least some of the merchants of the subgroup of the ranked set of similar merchants as recommendations;
a computer-readable storage medium comprising a specific recommendation tracking data structure which contains information about the recommendations of merchants made to the users; and
a computer system to compare part of the information in the recommendation tracking data structure with part of the information contained in the institution main data structure for at least:
(f) communicating to the merchants the recommendations that were made to users that have been followed within a selected timeframe by a transaction at the merchant for at least one set selected from the group consisting of the user's payment tools, the user's accounts, the user's relationship, and combinations thereof, being successful recommendations; and
(g) offering to the merchants access to a list of successful recommendations at the merchant.

22. The system of claim 21 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

23. In a computer system containing information related to at least one financial transaction network in a specific institution main data structure, a system for providing information on merchants to members, comprising:
a computer-readable storage medium comprising a specific community data structure which maps items from the institution main data structure database of members to sets of similar items from the institution main data structure database of members including items similarity index values, each index value indicating a degree of similarity between two items; and
a computer system for recommendation process which generates personalized recommendations to members by at least:
(a) accessing the community data structure to identify a corresponding set of similar members;
(b) for each member identified in step (a), identifying a set of associated merchants;
(c) combining the sets of merchants identified in step (b) to generate a ranked set of merchants in which the merchants are weighted by at least a function of at least a parameter selected from the group consisting of a constant, the number of appearances, the number of transactions, the value of transactions, the moment of the transactions, the value of the similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the member's payment tools behavior, the member's payment tools location, and combinations thereof; and
(e) communicating to the member information related to at least some of the merchants of the subgroup of the ranked set of similar merchants.

24. The system of claim 23 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.

25. In a computer system containing information related to at least one financial transaction network in a specific institution main data structure, a system for providing information on merchants to members, comprising:
a computer-readable storage medium comprising a community data structure which maps items from the institution main data structure database of members to sets of similar items from the institution main data structure database of members including items similarity index values, each index value indicating a degree of similarity between two items; and
a computer system for recommendation process which generates personalized recommendations to members by at least:
(a) accessing the community data structure to identify a corresponding set of similar members;
(b) for each member identified in step (a), identifying a set of associated merchants;
(c) combining the sets of merchants identified in step (b) to generate a ranked set of merchants in which the merchants are weighted by at least a function of at least a parameter selected from the group consisting of a constant, the number of appearances, the number of transactions, the value of transactions, the moment of the transactions, the value of similarity indexes, the user's communicated restrictions, the users' rating of merchants, external ratings of merchants, and combinations thereof;
(d) determining a subgroup of merchants from the ranked set of similar merchants in function of at least one parameter selected from the group consisting of the member's payment tools behavior, the member's payment tools location, and combinations thereof, and
(e) communicating to the member information related to at least some of the merchants of the subgroup of the ranked set of similar merchants as recommendations;
a computer-readable storage medium comprising a specific recommendation tracking data structure which contains information about the recommendations of merchants made to the members; and
a computer system to compare part of the information in the recommendation tracking data structure with part of the information contained in the institution main data structure for at least:
(f) communicating to the merchants the recommendations that were made to members that have been followed within a selected timeframe by a transaction at the merchant for at least one set selected from the group consisting of the member's payment tools, the member's accounts, the member's relationship, and combinations thereof, being successful recommendations; and
(g) offering to the merchants access to a list of successful recommendations at the merchant.

26. The system of claim 25 which further comprises:
a computer-readable storage medium comprising a specific merchant information data structure which contains items with information from the institution main data structure database of merchants and supplementary information; and
a computer system for users selected from the group consisting of merchants, members and non-members to access the merchant information data structure for at least one action selected from the group consisting of adding information, retrieving information, modifying information, and combinations thereof.
